(19) United States
(12) Patent Application Publication
(10) Pub. No.: US 2009/0164901 A1
(43) Pub. Date: Jun. 25, 2009

(54) ELECTRONIC DEVICE AND METHOD FOR QUICKLY PLAYING THROUGH MEDIA FILES

(75) Inventors: FANG-HUA LIU, Shenzhen City (CN); SHIH-FANG WONG, Tu-Cheng (TW); XIN LU, Shenzhen City (CN); BI-QING LUO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/272,796

(22) Filed: Nov. 18, 2008

(30) Foreign Application Priority Data
Dec. 21, 2007 (CN) 200710203335.3

(51) Int. Cl. G06F 3/00

(52) U.S. Cl. 715/716

(57) ABSTRACT

An electronic device capable of quickly playing through media files is provided, the electronic device includes an inputting unit configured for inputting operational signals in response to users' operations to the electronic device; a storage unit configured for storing a plurality of media files; a quickly playing through controlling module configured for controlling quickly playing through of media files according to operational signals inputted by the inputting unit, and obtaining a playing time interval confined by a playing start time and a playing termination time; a media file accessing module configured for accessing the storage unit and obtaining sections of the media files according to the playing time interval; a media file processing module configured for processing sections of the media files transmitted from the media file accessing module; a sound outputting unit configured for converting the sections of the media files processed by the media file processing module into audible sounds.

### BACKGROUND OF THE INVENTION

1. Field of the Invention

The present invention relates to an electronic device and a method for quickly playing through media files.

2. General Background

Electronic devices capable of playing media files are widely used as entertainment tools by users to enjoy music and songs. With the development of the electronic technology, the capacity of a storage unit applied in the electronic device is large enough to store hundreds of media files such as music files and song files and the like. Each media file has a duration time. When there is a need to play through the huge number of media files stored in the storage unit, it will take enormous time. If a user has to play through all the media files to find his favorites, it will inevitably be a waste of time for the user.

Therefore, it is necessary to provide an electronic device and method which can resolve the above-mentioned problem.

### SUMMARY OF INVENTION

An electronic device capable of quickly playing through media files is provided, the electronic device includes an inputting unit is configured for inputting operational signals in response to users' operations to the electronic device; a storage unit is configured for storing a plurality of media files; a quickly playing through controlling module is configured for controlling quickly playing through of media files according to operational signals inputted by the inputting unit, and obtaining a playing time interval confined by a playing start time and a playing termination time; a media file accessing module is configured for accessing the storage unit and obtaining sections of the media files according to the playing time interval; a media file processing module is configured for processing sections of the media files transmitted from the media file accessing module; a sound outputting unit is configured for converting the sections of the media files processed by the media file processing module into audible sounds.

### BRIEF DESCRIPTION OF DRAWINGS

FIG. 1 is a block diagram of an electronic device capable of quickly playing through media files in accordance with an embodiment.

FIG. 2 is a graph illustrates how to quickly play through the media files.

FIG. 3 is a flow chart of an exemplary method for quickly playing through media files of the electronic device of FIG. 1.

### DETAILED DESCRIPTION OF THE EMBODIMENTS

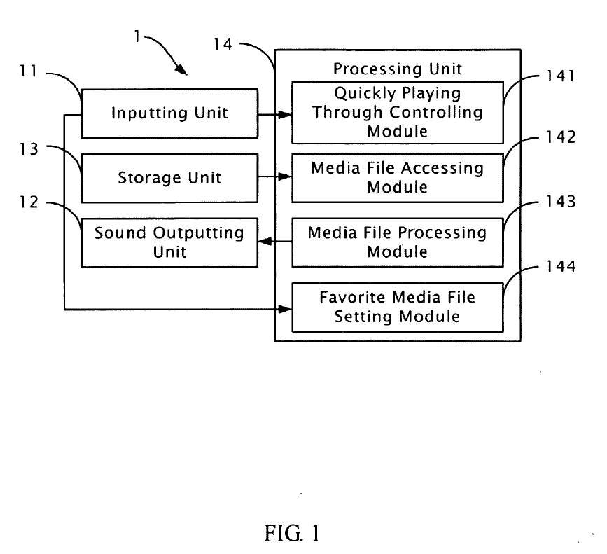

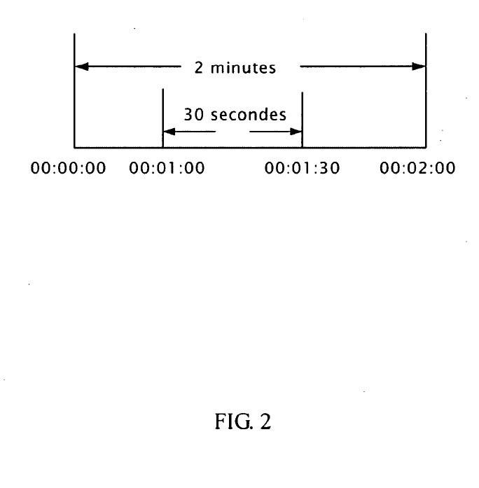

Referring to FIGS. 1 and 2, FIG. 1 is a block diagram of an electronic device (hereinafter “the electronic device 1”) capable of quickly playing through media files in accordance with an exemplary embodiment of the present invention. The electronic device 1 includes an inputting unit 11, a sound outputting unit 12, a storage unit 13 and a processing unit 14. The storage unit 13 is used for storing a plurality of media files. The media files may be song files, music files and the like. The inputting unit 11 is configured for inputting operational signals in response to users' operations to the electronic device 1. The processing unit 14 is configured for receiving and processing the operational signals and outputting corresponding commands to execute functions of the electronic device 1. The sound outputting unit 12 is configured for converting the media files stored in the storage unit 13 to audible sounds in accordance with the commands outputted by the processing unit 14.

The processing unit 14 includes a quickly playing through controlling module 141, a media file accessing module 142, a media file processing module 143 and a favorite media file setting module 144. The quickly playing through controlling module 141 is configured for receiving an operational signal inputted by users through the inputting unit 11, initiating and controlling the quickly playing through of the media files. The media file accessing module 142 is configured for accessing the media files stored in the storage unit 13 according to operational signals inputted by the users. The media file accessing module 142 is further configured for accessing the media files under the control of the quickly playing through controlling module 141 after the quickly playing through of the media files is actuated. The media file processing module 143 is configured for processing the media files accessed by the media file accessing module 142. The processing includes, but is not limited to, decoding the media files. The favorite media file setting module 144 is configured for setting a media file to be a favorite of the users. The setting includes storing the media file in a particular folder which is created to contain favorite media files or just marking the media file with a favorite symbol.

After the quickly playing through of media files is actuated, in a exemplary embodiment, the quickly playing through controlling module 141 further prompts the user to input a playing time interval through a display (not shown). The electronic device 1 receives the playing time interval inputted by the user through the inputting unit 11 and stores the playing time interval in the storage unit 13. Shown as FIG. 2, the playing time interval has a playing start time and a playing termination time. For example, if a media file has a playing time lasting for 2 minutes, the playing start time can be set as 00:01:00 and the playing termination time can be set as 00:01:30, which confine the playing time interval to be 30 seconds, the media file accessing module 142 accesses the media file and obtains a section of the media file between the time interval 00:01:00 and 00:01:30 under the control of the quickly playing through controlling module 141.

In an alternative exemplary embodiment, the storage unit 13 stores a predetermined playing time interval. After the quickly playing through of media files is actuated, the quickly playing through controlling module 141 reads the predetermined playing time interval from the storage unit 13 and controls the media file accessing module 142 to obtain sections of the media files corresponding to the predetermined playing time interval.

The media file accessing module 142 firstly accesses a first media file under a folder (or a playlist) of the storage unit 13, and obtains a section of the first media file in accordance with the playing time interval. The section of the first media file is transmitted to the media file processing module 143 to be processed and then is outputted by the sound outputting unit 12. The media file accessing module 142 secondly accesses a second media file and obtains a section of the second media file in accordance with the playing time interval. The section of the second media file is transmitted to the media file processing module 143 to be processed and then is outputted by the sound outputting unit 12. In the same manner, the electronic device 1 can quickly play through all of the media files under the same folder (or playlist).

In an exemplary embodiment, the electronic device 1 will further automatically continue to play through another folder (or playlist) in the storage after a folder (or playlist) is completed.

In an alternative embodiment, the electronic device 1 will ask the users to choose whether to continue with another folders (or playlists) when a folder (or playlist) is completed, and continues with the another folder (or playlist) when confirmed by the users.

During the course of quickly playing through the media files stored in a folder, if a terminating or a cancelling signal is received, the electronic device 1 stops the quickly playing through of the media files.

During the course of quickly playing through the media files, if the user makes a selection through the input unit 11 when a media file is being played through, the favorite media file setting module 144 sets the media file as a favorite of the user. In an exemplary embodiment, the favorite media file setting module 144 stores the media file in a particular folder which is created to contain favorite media files. In an alterative embodiment, the favorite media file setting module 144 marks the media file with a favorite symbol. The quickly playing through continues and when all of the media files stored in the folder are completed, or in an alternative embodiment all of the media files in the storage unit 13 are completed, the electronic device 1 automatically plays the media files selected by the users to be favorites. Each favorite media file lasts for its normally playing time.

In an alternative exemplary embodiment, during the course of quickly playing through the media files, if the user makes a selection through the input unit 11 when a media file is being played, the favorite media file setting module 144 informs the media file accessing module 142 to obtain the whole content of the media file. The whole content of the media file is transmitted to the media file processing module 143 to be processed and then is output by the sound outputting unit 12. After the whole content of the media file is played, the electronic device 1 continues the quickly playing through with a next media file.

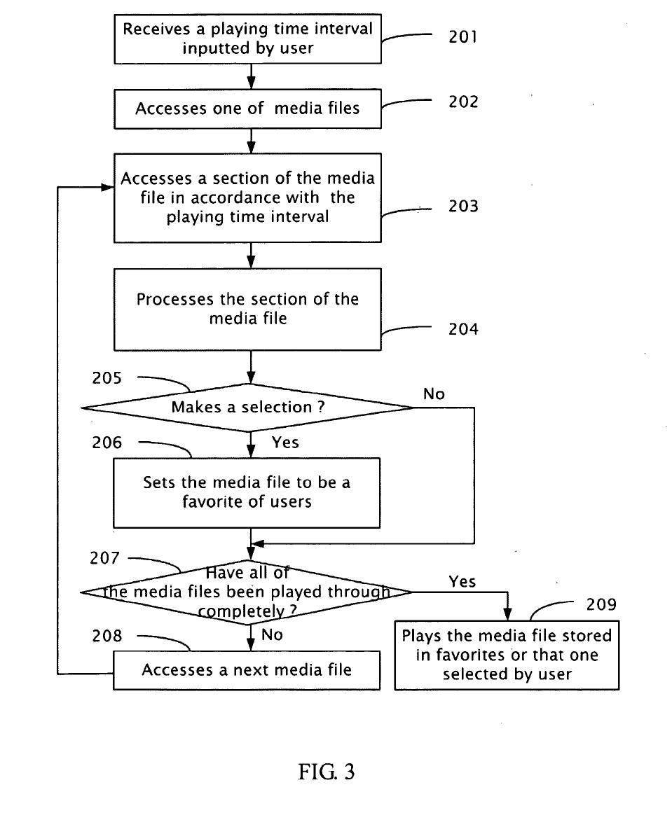

FIG. 3 is a flowchart of an exemplary method for quickly playing through media files of the electronic device 1. Firstly, in step 201, the electronic device 1 receives a playing time interval inputted by the user through the inputting unit 11, the playing time interval is confined by a playing start time and a playing termination time. In step 202, the media file accessing module 142 accesses a media file of the storage unit 13 (or under a folder of the storage unit 13). In step 203, the media file accessing module 142 obtains a section of the media file in accordance with the playing time interval. In step 204, the media file processing module 143 processes the section of the media file. In step 205, the favorite media file setting module 144 determines whether the user makes a selection through the inputting unit 11. If a selection is made, the procedure goes to step 206, in which the favorite media file setting module 144 sets the media file to be a favorite of the users. In an exemplary embodiment, the favorite media file setting module 144 stores the media file in a particular folder which is created to contain favorite media files. In an alternative embodiment, the favorite media file setting module 144 marks the media file with a favorite symbol. In step 207, the media file accessing module 142 determines whether all of the media files stored in the storage unit 13 (or in the folder) has been quickly played through. If not all of the media files has been quickly played through, the procedure goes into step 208, in which the media file accessing module 142 accesses a next media file, the procedure then returns to the step 203 described above. If all of the media files has been quickly played through, the procedure goes to step 209, in which the electronic device 1 plays the favorite media files set by the favorite media file setting module 144.

If no selection is made according to step 205, after the section of the media file is quickly played through, the procedure goes from step 205 directly to step 207.

In an alternative exemplary embodiment, if a selection is made according to step 206, the electronic device 1 stops the quickly playing through of media files. The media file accessing module 142 obtains the whole content of the media file from the storage unit 13 (or under a folder of the storage unit 13), thereby the electronic device 1 playing the whole media file. After the whole content of the media file is completed, the electronic device 1 continues the quickly playing through with a next media file. When all of the media files stored in the storage unit 13 (or in the folder) have been played through, the electronic device 1 exits from the quickly playing through of media files.

Based on the preferred embodiments disclosed above, an advantage of the present invention over the prior art becomes clear. The advantage is that the electronic device can quickly play through hundreds of media files and facilitate the users to finds their favorites among the hundreds of media files.

Although the present invention has been specifically described on the basis of an exemplary embodiment thereof, the invention is not to be construed as being limited thereto. Various changes or modifications may be made to the embodiments without departing from the scope and spirit of the invention.

What is claimed is:

1. An electronic device capable of quickly playing through media files, comprising:
an inputting unit configured for inputting operational signals in response to users' operations to the electronic device;
a storage unit configured for storing a plurality of media files;
a quickly playing through controlling module configured for controlling quickly playing through of media files according to operational signals inputted by the inputting unit, and obtaining a playing time interval confined by a playing start time and a playing termination time;
a media file accessing module configured for accessing the storage unit and obtaining sections of the media files according to the playing time interval;
a media file processing module configured for processing sections of the media files transmitted from the media file accessing module; and
a sound outputting unit configured for converting the sections of the media files processed by the media file processing module into audible sounds.

2. The electronic device as claimed in claim 1, further comprising a favorite media file setting module configured for setting a media file currently being played media file to be a favorite of the users according to the operational signals inputted by the inputting unit.

3. The electronic device as claimed in claim 2, wherein the media file accessing module is further configured for determining whether all of the media files in the storage unit has been quickly played through, and obtaining the whole content of the media files selected by the users to be favorites, thereby to play the favorite media files for their normal playing time.

4. The electronic device as claimed in claim 2, wherein the favorite media file setting module is further configured for informing the media file accessing module to obtain the whole content of a currently playing media file according to operational signals inputted by the inputting unit, thereby to play the media file for its normal playing time.

5. The electronic device as claimed in claim 1, wherein the playing time interval is pre-stored in the storage unit and the quickly playing through controlling module is configured for obtaining the playing time interval from the storage unit.

6. The electronic device as claimed in claim 1, wherein the playing time interval is inputted by the inputting unit and the quickly playing through controlling module is configured for obtaining the playing time interval from the inputting unit.

7. A method for quickly playing through media files, comprising:
receiving an operational signal to initiate quickly playing through of media files;
obtaining a playing time interval confined by a playing start time and a playing termination time;
accessing one of the media files;
obtaining a section of the media file in accordance with the playing time interval;
playing the section of the media file; and
accessing a next media file and repeating the steps of obtaining a section and of playing the section until all of the media files are quickly played through.

8. The method as claimed in claim 7, further comprising: receiving an operation signal to set the media file to be a favorite of the users before the step of accessing the next media file.

9. The method as claimed in claim 8, further comprising: automatically playing the favorite media file when all of the media files have been quickly played through.

10. The method as claimed in claim 8, further comprising: obtaining the whole content of the media file and playing the whole content of the favorite media file before the step of accessing the next media file.

11. The method as claimed in claim 7, wherein the step of obtaining the playing time interval comprises obtaining the playing time interval from a storage unit.

12. The method as claimed in claim 7, wherein the step of obtaining the playing time interval comprises obtaining the playing time interval from an inputting unit.
